(19) United States
(12) Patent Application Publication
(10) Pub. No.: US 2013/0234963 A1
(43) Pub. Date: Sep. 12, 2013

(54) FILE MANAGEMENT METHOD AND ELECTRONIC DEVICE HAVING FILE MANAGEMENT FUNCTION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: QI-LONG YU, Shenzhen (CN); TSUNG-JEN CHUANG, New Taipei (TW); JUN ZHANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/787,853

(22) Filed: Mar. 7, 2013

(30) Foreign Application Priority Data
Mar. 12, 2012 (CN) 201210063071.7

(51) Int. Cl. G06F 3/041

(52) U.S. Cl. CPC G06F 3/0412
USPC 345/173

(57) ABSTRACT

A computerized file management method for managing files of an electronic device, the electronic device includes a touch screen. A touch applied to an icon of a file is detected, and a determination made as to whether the touch is a held touch for more than a predetermined time. If the touch is held for more than the predetermined period, the direction in which the touch then slides is determined. A number of recognized directions in which a sliding touch can move are predetermined and a predetermined operation on the file is executed or a predetermined menu including a plurality of options is displayed on the touch screen, when the held touch slides along a recognized direction.

### BACKGROUND

1. Technical Field

Embodiments of the present disclosure relate generally to file management, and more particularly, to a file management method and an electronic device having the file management function.

2. Description of Related Art

Touch screens are used in many electronic devices, such as mobile phones, personal digital assistants (PDA), and portable computers. Electronic files stored in these electronic devices may be copied, pasted, moved, deleted, and renamed using the touch screen. However, a plurality of steps is required to execute any of the above mentioned functions, which is inconvenient and time consuming. Further, it may be difficult to copy, paste, move, delete, and rename the files only by general touch operations on mere representations (icons) of the files displayed on the touch screen. Therefore, there is room for improvement in the art.

### BRIEF DESCRIPTION OF THE DRAWINGS

FIG. 1 is a block diagram illustrating one embodiment of an electronic device including a file management unit.

FIG. 2 shows a four predetermined directions which a touch applied to an icon may slide along.

FIG. 3 shows a flowchart of one embodiment of a file management method of the electronic device of FIG. 2.

FIG. 4 shows the process of an example of step S4 of the method of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

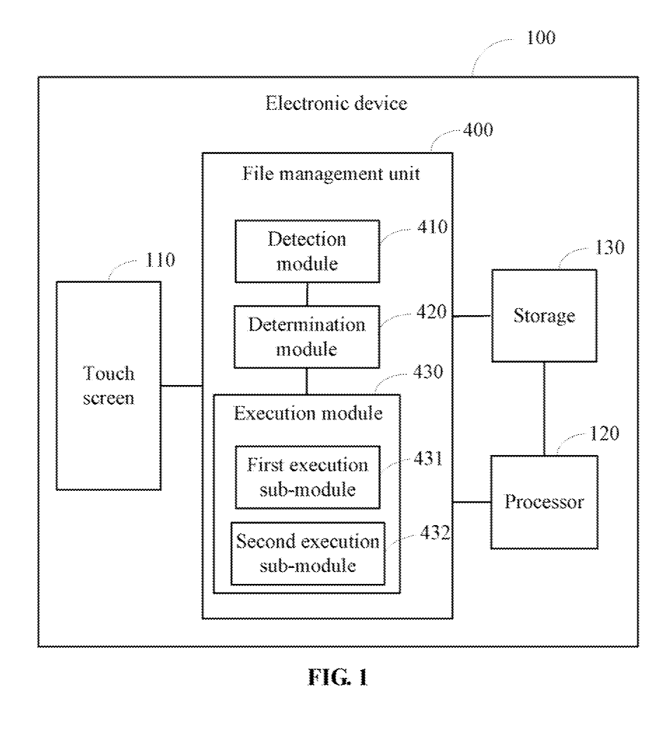

FIG. 1 shows a block diagram of one embodiment of an electronic device 100. The electronic device 100 includes a touch screen 110, a processor 120, a storage 130, and a file management unit 400. In the embodiment, the touch screen 110 may be capacitive or resistive. The file management unit 400 can detect touches applied to icons of different files of the electronic device 100, and execute predetermined functions (e.g., to copy, move, and rename) on the files corresponding to the icons according to the touches. The electronic device 100 may be, for example, a mobile phone, a personal digital assistant, a portable computer, or similar device having the touch screen 110. FIG. 1 shows one example of the electronic device 100, and the electronic device 100 can include more or fewer components than shown in the embodiment, or have a different configuration of the components.

The file management unit 400 may include a plurality of programs in the form of one or more computerized instructions stored in the storage 130 and executed by the processor 120 to perform operations of the electronic device 100. In the embodiment, the file management unit 400 includes a detection module 410, a determination module 420, and an execution module 430. In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The detection module 410 detects touches applied to icons of files of the electronic device 100. The touches may be done with a finger or a tool, such as a stylus. The files may be files of various applications, photos, documents, or others similar files stored in the storage 130 of the electronic device 100.

When a touch applied to an icon of a file is detected, the determination module 420 determines whether the touch is a held touch lasting for more than a predetermined time, such as two or three seconds. If the touch is the held touch, the determination module 420 determines whether the held touch slides along one of a number of predetermined directions, the number of predetermined directions being one or more.

If the held touch does slide along one predetermined direction, the execution module 430 executes a predetermined operation on the file, for example, copying or deleting the file. In the embodiment, each of the predetermined directions corresponds to a predetermined operation, and the predetermined operation executed by the execution module 430 corresponds to a predetermined direction.

In other embodiments, if the held touch slides along a predetermined direction, the execution module 430 may display a predetermined menu including a plurality of options (e.g., “save as”, “move”, “rename”, “copy”, and “delete”) on the touch screen 110, and then execute a function corresponding to the option selected by a user.

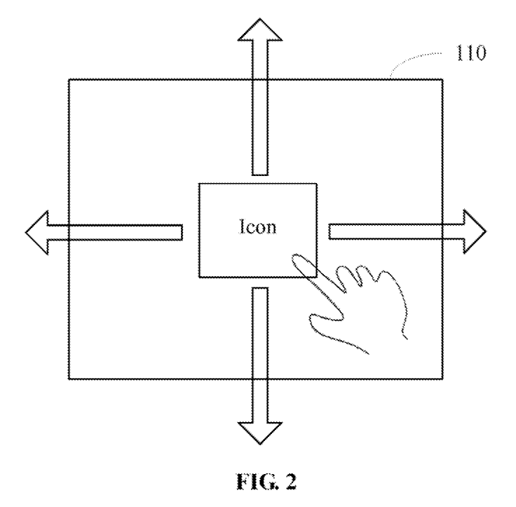

In one example, as shown in FIG. 2, the predetermined directions may include a first, second, third, and fourth predetermined directions, which are substantially left, right, up, and down. The execution module 430 includes a first execution sub-module 431 and a second execution sub-module 432. When the held touch slides along the first predetermined direction, the first execution sub-module 431 executes a first predetermined operation on the file (e.g., to copy the file), or the second execution sub-module 432 displays a first predetermined menu including a first group of options on the touch screen 110. When the held touch slides along the second predetermined direction, the first execution sub-module 431 executes a second predetermined operation on the file (e.g., to rename the file), or the second execution sub-module 432 displays a second predetermined menu including a second group of options on the touch screen 110. When the held touch slides along the third predetermined direction, the first execution sub-module 431 executes a third predetermined operation on the file (e.g., to move the file), or the second execution sub-module 432 displays a third predetermined menu including a third group of options on the touch screen 110. When the held touch slides along the fourth predetermined direction, the first execution sub-module 431 executes a fourth predetermined operation on the file (e.g., to delete the file), or the second execution sub-module 432 displays a fourth predetermined menu including a fourth group of options on the touch screen 110. Further, when any option of the first, second, third, and fourth predetermined menus is selected, a function corresponding to the selected option is executed by the second execution sub-module 432. In addition, the first, second, third and fourth predetermined menus have different group of options from each other.

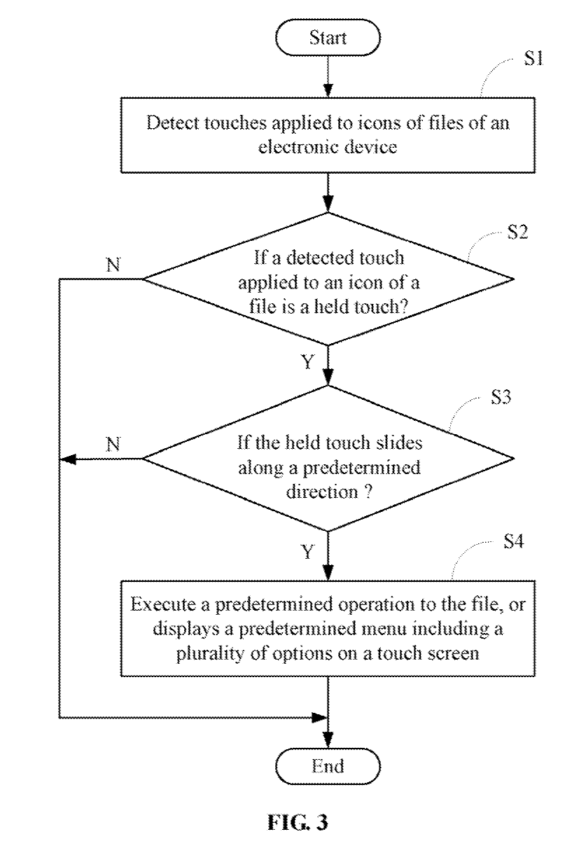

FIG. 3 shows a flowchart of one embodiment of a file management method of the electronic device 100 of FIG. 1. Depending on the embodiment, additional steps may be added, others removed, and the ordering of the steps may be changed.

In step S1, the detection module 410 detects touches applied to icons of files (e.g., files of various types and applications) of the electronic device 100.

In step S2, when a touch applied to an icon of a file is detected, a determination is made by the determination module 420 as to whether the touch is a held touch lasting for more than a predetermined time (e.g., two or three seconds). If the touch is a held touch, the process goes to step S3. If the touch is not a held touch, the process terminates.

In step S3, the determination module 420 determines whether the held touch slides along one of a number of predetermined directions, the number of predetermined directions being one or more. If the held touch does slide along one predetermined direction, the process goes to step S4. Otherwise, if the held touch does not slide along any of the predetermined directions, the process terminates.

In step S4, the execution module 430 executes a predetermined operation on the file, or displays a predetermined menu including a plurality of options (e.g., “save as”, “move”, “rename”, “copy”, and “delete”) on the touch screen 110.

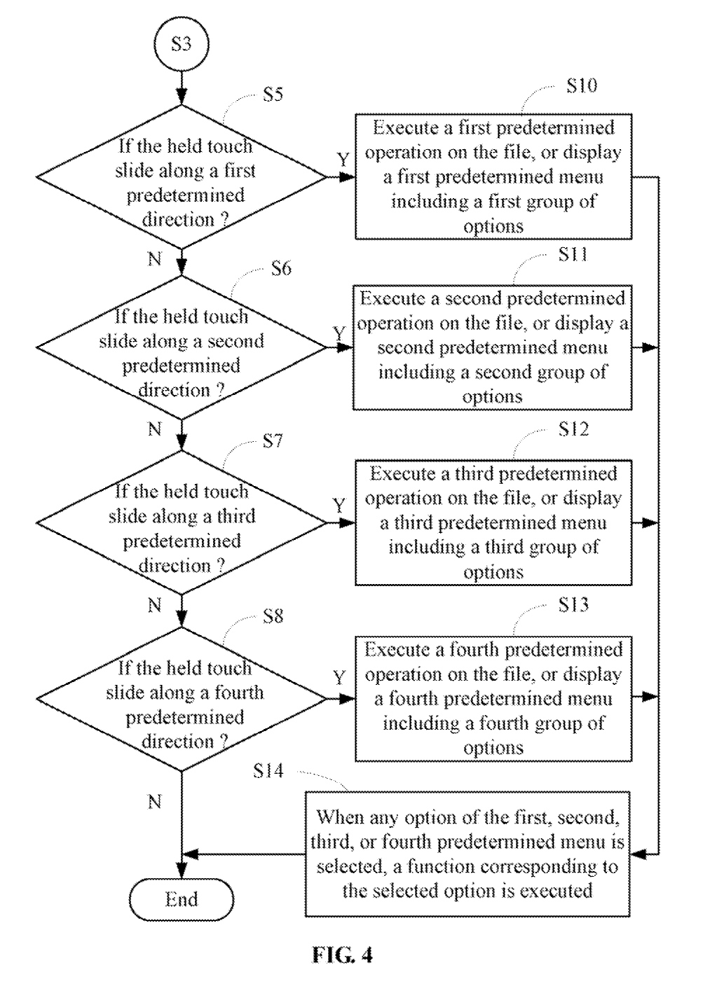

Under the condition that the predetermined menu has been displayed on the touch screen, when an option of the predetermined menu is selected by a user, the execution module 430 executes the function corresponding to the selected option. In one example of the present embodiment, the predetermined directions include a first, second, third, and fourth predetermined directions, which are substantially left, right, up, and down. FIG. 4 shows the detail of the process of step S4 based on the four predetermined directions, which are implemented by the first and second execution sub-modules 431, 432.

In step S5, the determination module 420 determines whether the held touch slides along the first predetermined direction, and if the held touch does slide along the first predetermined direction, step S10 is implemented. Otherwise, the procedure goes to step S6.

In step S6, the determination module 420 determines whether the held touch slides along the second predetermined direction, and if the held touch does slide along the second predetermined direction, step S11 is implemented. Otherwise, the procedure goes to step S7.

In step S7, the determination module 420 determines whether the held touch slides along the third predetermined direction, and if the held touch does slide along the third predetermined direction, step S12 is implemented. Otherwise, the procedure goes to step S8.

In step S8, the determination module 420 determines whether the held touch slides along the fourth predetermined direction, and if the held touch does slide along the fourth predetermined direction, step S13 is implemented. Otherwise, the procedure terminates.

In step S10, the first execution sub-module 431 executes a first predetermined operation on the file (e.g., to copy the file), or the second execution sub-module 432 displays a first predetermined menu including a first group of options. Then the procedure goes to step S14.

In step S11, the first execution sub-module 431 executes a second predetermined operation on the file (e.g., to rename the file), or the second execution sub-module 432 displays a second predetermined menu including a second group of options. Then the procedure goes to step S14.

In step S12, the first execution sub-module 431 executes a third predetermined operation on the file (e.g., to move the file), or the second execution sub-module 432 displays a third predetermined menu including a third group of options. Then the procedure goes to step S14.

In step S13, the first execution sub-module 431 executes a fourth predetermined operation on the file (e.g., to delete the file), or the second execution sub-module 432 displays a fourth predetermined menu including a fourth group of options. Then the procedure goes to step S14.

In step S14, under the condition that the first, second, third, or fourth predetermined menus is displayed on the touch screen 110, the function corresponding to the selected option is executed by the second execution sub-module 432 when an option of the first, second, third, or fourth predetermined menus is selected.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a touch screen;
a storage storing a plurality of files;
a processor; and
a file management unit having one or more programs stored in the storage and executed by the processor, the file management unit comprising:
a detection module that detects touches applied to icons of the files, the icons being displayed on the touch screen;
a determination module that determines whether a detected touch applied to an icon of a file is a held touch lasting for more than a predetermined time, and in response to the detected touch being determined as the held touch, determines whether the held touch slides along one of a number of predetermined directions, the number of predetermined directions being one or more; and
an execution module that executes a predetermined operation on the file, or displays a predetermined menu comprising a plurality of options on the touch screen according to a slide action of the held touch when the held touch slides along one predetermined direction.

2. The electronic device according to claim 1, wherein when an option of the predetermined menu is selected under the condition that the predetermined menu has been displayed on the touch screen, the execution module further executes a function corresponding to the selected option.

3. The electronic device according to claim 1, wherein each of the predetermined directions corresponds to a predetermined operation and the predetermined operation executed by the execution module corresponds to a predetermined direction.

4. The electronic device according to claim 1, wherein the execution module comprises a first execution sub-module and a second execution sub-module, and the predetermined directions comprise a first predetermined direction, a second predetermined direction, a third predetermined direction, and a fourth predetermined direction.

5. The electronic device according to claim 4, wherein:
when the held touch slides along the first predetermined direction, the first execution sub-module executes a first predetermined operation on the file;
when the held touch slides along the second predetermined direction, the first execution sub-module executes a second predetermined operation on the file;
when the held touch slides along the third predetermined direction, the first execution sub-module executes a third predetermined operation on the file; and
when the held touch slides along the fourth predetermined direction, the first execution sub-module executes a fourth predetermined operation on the file.

6. The electronic device according to claim 4, wherein:
when the held touch slides along the first predetermined direction, the second execution sub-module displays a first predetermined menu including a first group of options on the touch screen;
when the held touch slides along the second predetermined direction, the second execution sub-module displays a second predetermined menu including a second group of options on the touch screen;
when the held touch slides along the third predetermined direction, the second execution sub-module displays a third predetermined menu including a third group of options on the touch screen; and
when the held touch slides along the fourth predetermined direction, the second execution sub-module displays a fourth predetermined menu including a fourth group of options on the touch screen.

7. The electronic device according to claim 6, wherein when any option of the first, second, third, and fourth predetermined menus is selected, the second execution sub-module executes a function corresponding to the selected option.

8. A computerized file management method for managing files of an electronic device having a touch screen, the method comprising:
detecting touches applied to icons of the files in, the icons being displayed on the touch screen;
determining whether a detected touch applied to an icon of a file is a held touch lasting for more than a predetermined time;
determining whether the held touch slides along one of a number of predetermined directions when the detected touch is determined as the held touch; and
executing a predetermined operation on the file, or displaying a predetermined menu comprising a plurality of options on the touch screen according to a slide action of the held touch when the held touch slides along one predetermined direction.

9. The method according to claim 8, further comprising:
executing a function corresponding to an option of the predetermined menu, when the option is selected after the predetermined menu has been displayed on the touch screen.

10. The method according to claim 8, wherein each of the predetermined directions corresponds to a predetermined operation and the executed predetermined operation corresponds to a predetermined direction.

11. The method according to claim 8, wherein the predetermined directions comprises a first predetermined direction, a second predetermined direction, a third predetermined direction, and a fourth predetermined direction.

12. The method according to claim 11, further comprising:
executing a first predetermined operation on the file, when the held touch slides along the first predetermined direction;
executing a second predetermined operation on the file, when the held touch slides along the second predetermined direction;
executing a third predetermined operation on the file, when the held touch slides along the third predetermined direction; and
executing a fourth predetermined operation on the file, when the held touch slides along the fourth predetermined direction.

13. The method according to claim 11, further comprising:
displaying a first predetermined menu including a first group of options on the touch screen, when the held touch slides along the first predetermined direction;
displaying a second predetermined menu including a second group of options on the touch screen, when the held touch slides along the second predetermined direction;
displaying a third predetermined menu including a third group of options on the touch screen, when the held touch slides along the third predetermined direction; and
displaying a fourth predetermined menu including a fourth group of options on the touch screen, when the held touch slides along the fourth predetermined direction.

14. The method according to claim 13, further comprising:
executing a function corresponding to a selected option of the first, second, third, or fourth predetermined menus.
